(19) United States
(12) Patent Application Publication
(10) Pub. No.: US 2004/0221896 A1
(43) Pub. Date: Nov. 11, 2004

(54) Position detector for an electro hydraulic servo valve

(76) Inventors: Devane R. Ballenger, Mishawaka, IN (US); David D. Jones, Granger, IN (US); Ivan P. Lebrun, Granger, IN (US); Mark E. Behnke, South Bend, IN (US); Michael C. Janosik, (US)

Correspondence Address: Larry J. Palguta, Honeywell International Inc., 3520 Westmoor Street, South Bend, IN, 46628, US

(21) Appl. No.: 10/431,891

(22) Filed: May 8, 2003

(51) Int. Cl. F16K 37/00

(52) U.S. Cl. 137/554

(57) ABSTRACT

An electro-hydraulic servo valve (61) is provided, which includes a torque motor (63) and a position sensor (37) attached to a housing (67) of the electro-hydraulic servo valve (61). A spool valve (69) is disposed within a bore (71) of the housing (67) and is connected to the torque motor (63) such that it can move linearly within the bore (71) of the housing (67). The position sensor (37) determines the position of the spool valve (69) within the bore (71), and extends through the housing (67) such that it is connected to the spool valve (69) perpendicularly to the linear movement of the spool valve (69).

### BACKGROUND OF THE INVENTION

1. Field of the Invention

The present invention relates to a piezo-resistive position indicator for detecting a position of a spool valve of an electro-hydraulic servo valve.

2. Description of the Background Art

An electro-hydraulic servo valve (EHSV) is an essential item of servomechanism where fast speed of response, high power output, and working fidelity are necessary. Recently, new applications using EHSVs have necessitated more stringent specifications with respect to positioning accuracy, speed and user-friendliness.

EHSVs convert electrical control signals into output hydraulic signals for application to a fluid motor for use in various applications. These applications may include movement of aerodynamic control surfaces of an aircraft, control of a variable displacement pump fuel metering system, loading and unloading of ships with crane systems, automated masonry construction using a mobile robot, automated washers for commercial airplanes, etc.

FIG. 1 shows a schematic illustration of a conventional EHSV 1 having a torque motor 3 attached to a housing 5 of the EHSV 1. The EHSV 1 may be connected to an actuator 7, which in turn can position a load 9 in accordance with signals that are applied to the motor 3. Within the housing 5, a spool valve 11 having lands 13, 15 on each end thereof is disposed in a bore 17 of the housing 5. The motor 3 is connected to the spool valve 11 via a shaft 19 in order to linearly move the spool valve 11 within the bore 17. When electrical signals are applied to the motor 3, the spool valve 11 is moved in a desired direction and depending on that direction fluid from a pressure source 21 travels through one of the passage ways 23, 24 to respective chambers 25, 26 of the actuator 7 in order to position the load 9.

U.S. Pat. No. 5,285,715 discloses an EHSV having a linear potentiometer position sensor in order to provide feedback on the position of the spool of the EHSV. U.S. Pat. No. 5,504,409 discloses, and as shown in FIG. 2, an EHSV 1 having a Linear Variable Differential Transformer (LVDT) 27 externally affixed to the housing 5 of the EHSV 1 in order to provide positioning information on the spool valve 11 of the EHSV 1. The torque motor 3 moves the spool valve 11 via a drive ball 29 within the housing 5 of the EHSV 1 such that the spool valve 11 travels in a linear direction to and from the LVDT 27. A LVDT is basically a series of inductors in a hollow cylindrical shaft having a solid cylindrical core movable therein. The LVDT produces an electrical output proportional to the displacement of the movable magnetic core.

Using a LVDT to detect the position of a spool valve of an EHSV, however, has drawbacks associated therewith. For example, because the LVDT can only be positioned at a linear end of the spool valve, where the pressure of the fluid is greatest, there arises sealing problems between the housing of the EHSV and the LVDT. Furthermore, LVDTs must be adapted to specifically conform to EHSVs having various housing designs. Also, LVDTs are susceptible to vibrations, which leads to faulty position measurements of the spool valve. Moreover, LVDTs, because of their complexity, are heavy in weight, which is undesirable and further leads to adverse effects from vibrations.

Other conventional valve position sensors, such as limit switches and potentiometers have low reliability because of their reliance on electrical contacts, which tend to wear and deteriorate relatively quickly. Comparatively reliable sensors, such as a rotary variable differential transformer (RVDT) and the above-discussed LVDTs are expensive. Other position sensors, such as eddy current sensors, Hall effect sensors, proximity sensors, and the like can only operate in a limited temperature range.

Accordingly, a position sensor representing an improvement over the conventional art, as discussed above, is desirable. In particular, a position sensor that is simple, cost-effective to manufacture and implement, interchangeable, and able to work in a wide range of environments is desirable.

### SUMMARY OF THE INVENTION

It is therefore an object of the present invention to provide an electro-hydraulic servo valve including a torque motor attached to the housing of a hydraulic valve; a spool valve disposed within a bore of the housing and being connected to the torque motor such that it can move linearly within the bore of the housing; and a position feedback sensor. The position sensor determines the position of the spool valve within the bore, and extends through the housing such that it is connected to the spool valve perpendicularly to the linear movement of the spool valve.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic illustration of a conventional EHSV;

FIG. 2 is a schematic illustration of a conventional EHSV having a LVDT affixed thereto;

FIG. 3 is a linear curve representing ideal flow versus spool valve position;

FIG. 4 is a top view of a position sensor according to a preferred embodiment of the present invention;

FIG. 5 is schematic illustration of a Wheatstone bridge, which is incorporated into a preferred embodiment of the invention;

FIG. 6 is another schematic illustration of the Wheatstone bridge of FIG. 5;

FIG. 7 is an illustration of a position sensor mounted in an EHSV according to a preferred embodiment;

FIG. 8 is a cross-section of the EHSV with the mounted position sensor of FIG. 7;

FIG. 9 is a top cross-section of the EHSV showing the mounted position sensor of FIG. 7;

FIG. 10 is a schematic illustration of a position sensor connected to a spool valve of an EHSV;

FIG. 11 is a schematic illustration of an EHSV according to a second embodiment of the invention; and

FIG. 12 is a schematic illustration of an EHSV according to a third embodiment of the invention.

### DETAILED DESCRIPTION OF THE PREFERRED EMBODIMENTS

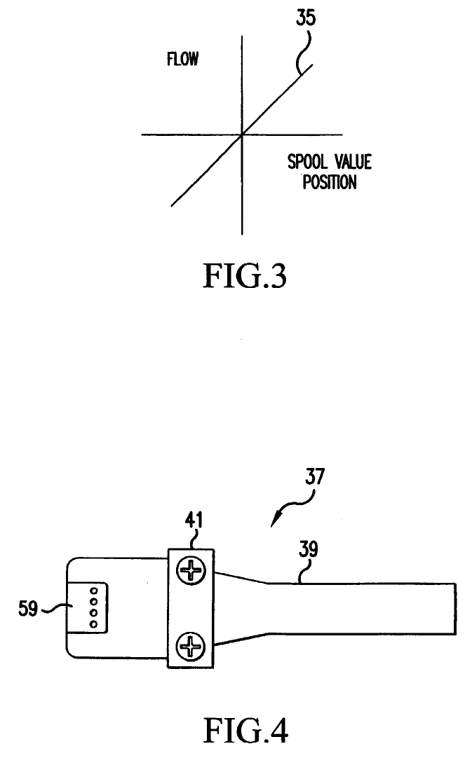

It is well known to those skilled in the art that a linear curve 35 is the ideal curve representing flow versus spool valve position, as shown in FIG. 3. It is also known that the shape of ports (not shown) of an EHSV can alter the flow characteristics, e.g., if a port is rectangular or circular. Therefore, in order to control this optimal linear curve it is necessitated that the position of the spool valve be accurately determined. In order to determine the position of a spool valve of, for example, an EHSV, a position sensor according to the present invention is provided, as discussed in detail hereinbelow.

FIG. 4 illustrates a position sensor 37 according to a preferred embodiment of the present invention. The position sensor 37 has a sensor beam 39 extending outwardly from or through a fastening portion 41. This sensor beam 39 is made of a thin sheet metal substrate that permits the sensor beam 39 to resiliently deflect from a neutral position and return. In other words, the sensor beam 39 returns to a neutral orientation or position after being resiliently deflected. The sensor beam 39 may also be made from, without limitation, metal, plastics, resins, etc. having mechanical characteristics (including size and thickness) that permit resilient deflection from a neutral position. The material from which the sensor beam 39 is made, may additionally be coated with one or more coatings to alter the mechanical and electrical characteristics thereof, such as, without limitation, resistance to thermal distortion, electromagnetic properties, and durability. See, for example, U.S. Pat. No. 6,308,723 to Louis et al., the contents of which are incorporated herein by reference, see also U.S. Pat. No. 4,794,048 to Oboobi et al., the contents of which are also incorporated herein by reference. Further, the sensor beam 39 may have a variety of shapes, such as rectangular or trapezoidal. The shape of the sensor beam 39 also has an effect on operation of the position.

Disposed on the sensor beam 39 are piezo-resistive components, the resistance of which changes when strained and which are coated with and fixed by, for example, glass or ceramic. The arrangement of the piezo-resistive components incorporated by the sensor beam 39 is such as to form a Wheatstone bridge, although other similarly functioning circuit configurations, such as a well-known half-bridge configuration, may be substituted. It is noted that a strain applied to a Wheatstone bridge measurably and selectively alters some or all of the resistances of the Wheatstone bridge in proportion to the strain applied thereto, which in turn is proportional to the amount of deflection of the sensor beam 39.

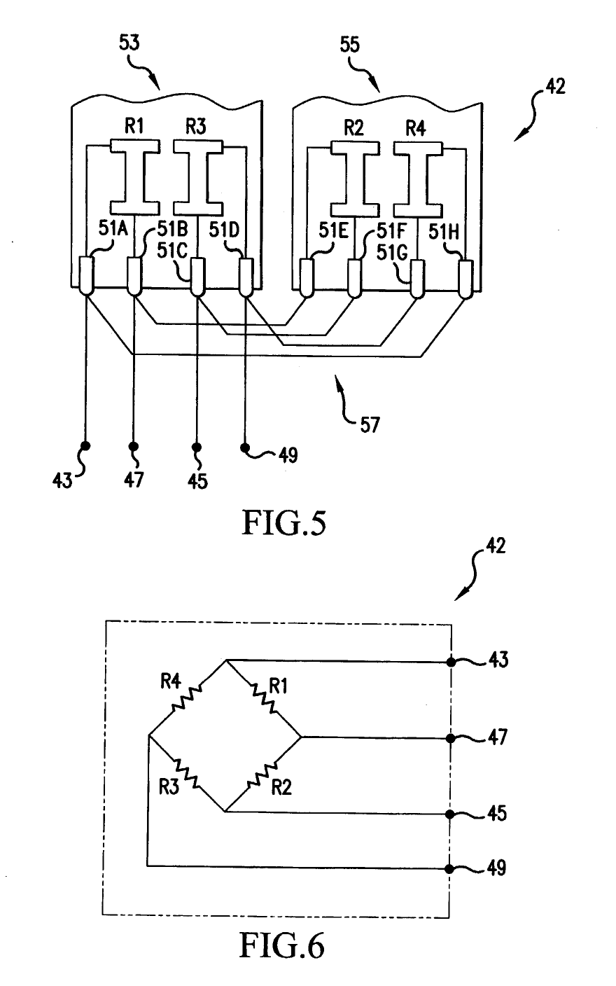

Referring to FIGS. 5 and 6, a Wheatstone bridge 42 is illustrated, which includes a voltage input 43 that receives a continuous supply of voltage, a ground 45, output terminals 47, 49, eight terminals 51a-h, and resistors R1-R4. As shown in FIG. 5, the resistors R1 and R3 may be, for example, placed on an upper surface 53 of the sensor beam 39, and resistors R2 and R4 may be, for example, placed on a lower surface 55 of the sensor beam 39. Resistors R1-R4 are electrically connected to one another, the voltage input 43, the ground 45, and the output terminals 47, 49 via connector lines 57. A second Wheatstone bridge (not shown) may be provided onto the sensor beam 39 in order to provide dual redundant implementation, as discussed further hereinbelow.

Additionally, a temperature sensor (not shown) may be mounted on the sensor beam 39 in addition to the Wheatstone bridge 42 such that, for example, the resistors R1-R4 can be calibrated due to temperature fluctuations. This calibration may be performed in an external unit.

Electrical leads to the Wheatstone bridge 42 are connected to or interfaced in a connector 59 of the position sensor 37, as shown in FIG. 4. The connector 59 may, for example, provide an electrical connection to a known device for determining the deflection of the sensor beam 39 of the position sensor 37.

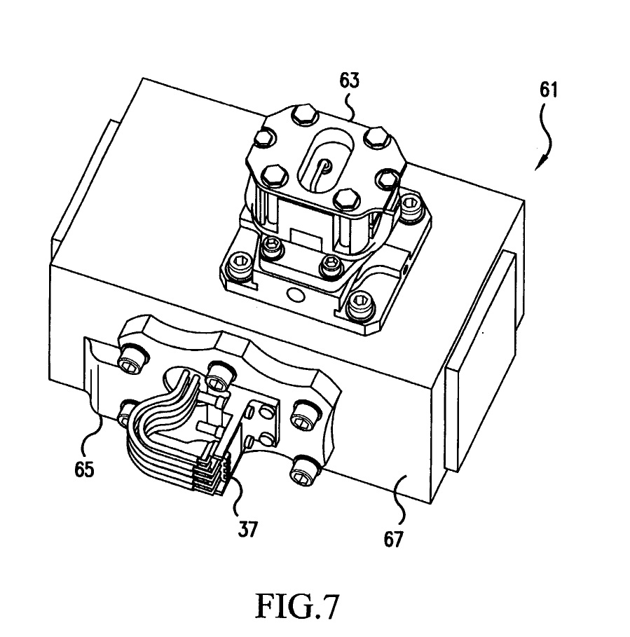

FIG. 7 illustrates the position sensor 37 mounted in an EHSV 61 according to a preferred embodiment of the present invention. The EHSV 61 further includes a housing 67 with a torque motor 63 mounted thereon. The position sensor 37 is mounted to the housing 67 of the EHSV 61 via a mounting skim 65, which allows precise positioning of the position sensor 37 within the EHSV 61, so that optimum calibration can be achieved.

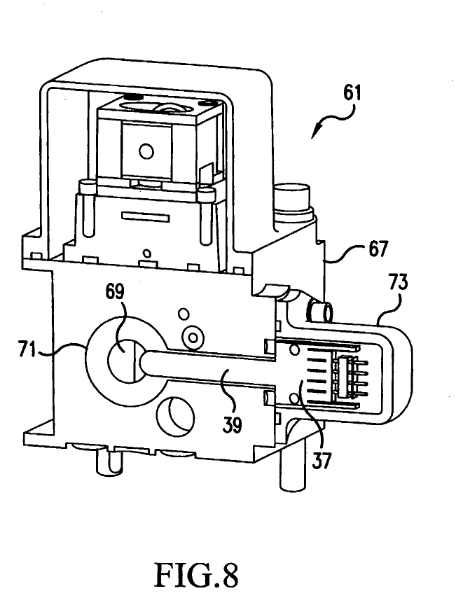

FIG. 8 is a cross-sectional view of the position sensor 37 mounted within the housing 67 of the EHSV 61. The sensor beam 39 extends through the housing 67 to a spool valve 69, which is mounted within a bore 71 of the housing 67. Further, a sensor housing 73 is provided, which encompasses the position sensor 37 for thermal and component protection. The sensor housing 73 is mounted to the housing 67 of the EHSV 61 by any conventional method.

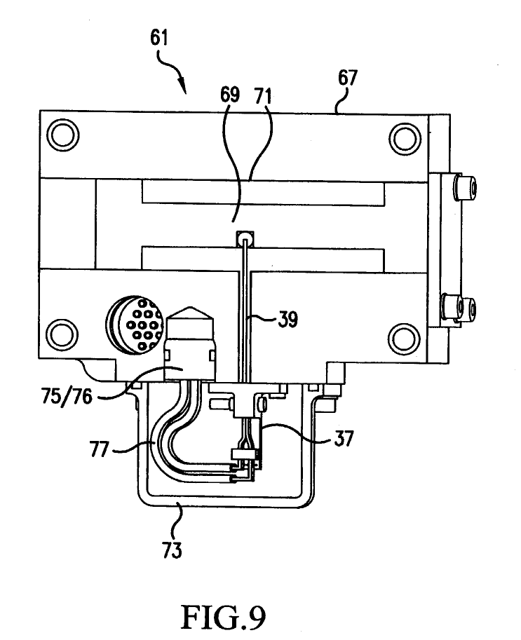

FIG. 9 is a top cross-sectional view of the EHSV 61, showing the sensor beam 39 of the position sensor 37 extending through the housing 67 to the spool valve 69. Further, a connector assembly 75 may be provided in an aperture of the housing 67 of the EHSV 61 for receiving signals via electrical lines 77 from the position sensor 37 and providing these signals to an external processing device (not shown), such as for example, a FADEC (Fully Automated Digital Electronic Control), which then determines the deflection of the sensor beam 39. Additionally, a controller 76 may be included with or may replace the connector assembly 75 for determining the deflection of the sensor beam 39. The connector assembly 75 or controller 76 may also be mounted to an exterior portion of the housing 67 or may receive signals from the position sensor 37 wirelessly at a remote location.

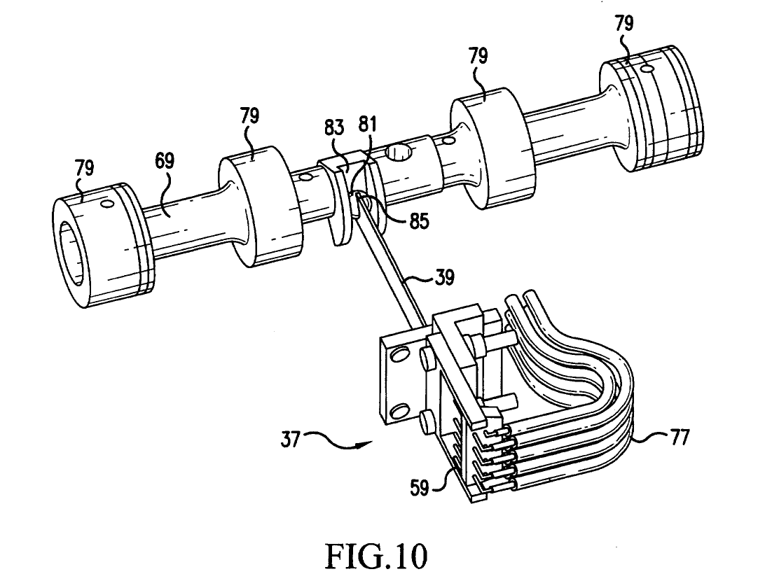

FIG. 10 shows a schematic illustration of the position sensor 37 being connected to the spool valve 69. As can be seen in the figure, the spool valve 69 has lands 79 formed thereon. Although only four lands 79 are shown, the spool valve 69 can have any number of lands formed thereon, depending on the requirements of the EHSV 61. The sensor beam 39 of the position sensor 37 is movably, e.g., slidably, held, perpendicularly, along a portion of the spool valve 69 by interconnecting with a slip-fitted ball 81. This slip-fitted ball 81 is movably held onto the spool valve 69 by being positioned in a groove 83 formed between the lands 79. This slip-fitted ball 81 is attached to an end portion 85 of the sensor beam 39 by any conventional method. Furthermore, the slip-fitted ball 81 is made of a highly wear resistant material.

In particular, it should be appreciated that because the position sensor 37 is positioned between the lands 79 of the spool valve 69, the pressure induced by the fluid is less than the pressures incurred within the bore 71, outside of the lands 79. As such, leakage risks are minimized at, for example, the mounting skim 65, which, as stated above, mounts the position sensor 37 to the housing 67. Furthermore, the same position sensor 37 can be integrated into various EHSVs that have different housing configurations, therefore reducing manufacturing costs. A further additional benefit of using the position sensor 37 of the present invention is that it weighs approximately one half that of the LVDT, thereby minimizing the weight of the EHSV 61.

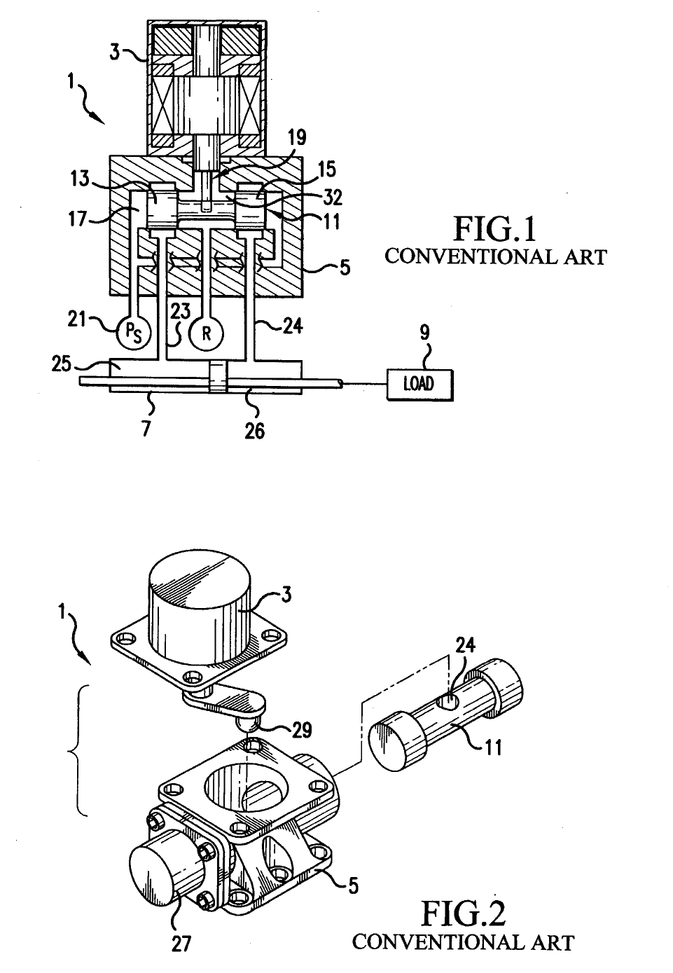

An operation of the position sensor 37 in the EHSV 61 will now be explained. The torque motor 63, upon receiving a signal, moves the spool valve 69 in a linear direction along the bore 71 within the housing 67 of the EHSV 61. Depending on the position of the lands 79 within the housing 67, fluid that is under pressure is directed through respective channels, similarly as shown in FIG. 1, in order to move a load. As the spool valve 69 is moved, the sensor beam 39 of the position sensor 37 deflects respectively to the direction of the spool valve 69. Depending on the amount of this deflection, the resistance of the piezo-electric components changes (as discussed above) and an output is provided to the connector assembly 75 via the electrical lines 77. The connector assembly 75 may either further this output, for example, to the FADEC in order to determine the linear position of the spool valve 69 within the bore 71 of the housing 67 of the EHSV 61 or to the controller 76, which as stated above, may be included in the connector assembly 75, in order to determine the linear position of the spool valve 69. This linear position, in conjunction with other predetermined values, such as flow rate, etc., is utilized by the torque motor 63 in order to accurately position the spool valve 69.

Although the operation of the position sensor 37 has been described above with an EHSV 61 having a torque motor 63, the position sensor 37 may also be provided in a two-stage EHSV (not shown), whereby the spool valve 69 is moved by other known methods, such as hydraulically, pneumatically, etc.

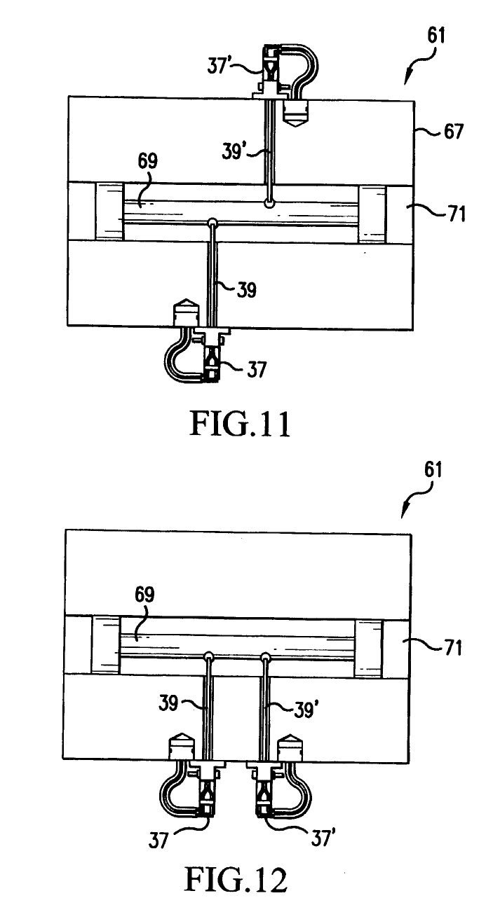

In some applications, for example, aerospace, a dual redundant implementation may be required to improve reliability and fault tolerance. As stated above, a second Wheatstone bridge (not shown) may be provided on the sensor beam 39 or additional position sensors may be provided. FIG. 11 shows an example of a second position sensor 37′ having its sensor beam 39′ connected to the spool valve 69 of the EHSV 61. The second position sensor 37′, in this embodiment, is positioned opposite the position sensor 37 and provides for redundant measurements. Although, the second position sensor 37′ is shown in FIG. 11 as being offset, in a linear direction of the spool valve 69, the second position sensor 37′, in an alternate embodiment, may be directly opposite the position sensor 37. Alternatively, the second position sensor 37′ may be positioned parallel to the position sensor 37, such that their respective sensor beams 39, 39′ are connected on a same side of the spool valve 69, as shown in FIG. 12. In the above-described redundant systems, if one of the position sensors were to fail, the other could be used instead. Additionally, the outputs of each of the position sensors 37, 37′ can be “matched” with each other in order to determine errors or to provide for an average, in order to determine the position of the spool valve 69.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electro-hydraulic servo valve comprising:
a spool valve disposed within a bore of a housing of the electro-hydraulic servo valve such that it can be moved linearly within the bore of the housing; and
a position sensor for determining the position of the spool valve within the bore, the position sensor including a sensor beam having piezo-resistive components mounted thereon,
wherein the sensor beam extends through the housing and is connected to the spool valve perpendicularly to the linear movement of the spool valve such that the sensor beam deflects in accordance with the position of the spool valve.

2. The electro-hydraulic servo valve according to claim 1, wherein the position sensor is connected to the spool valve between lands formed on outer portions of the spool valve.

3. The electro-hydraulic servo valve according to claim 1, wherein the piezo-resistive components provide resistance changes in relation to a deflection amount of the sensor beam to thereby provide position information of the spool valve.

4. The electro-hydraulic servo valve according to claim 1, wherein the sensor beam is connected to the spool valve by a slip-fitted ball.

5. The electro-hydraulic servo valve according to claim 4, wherein the slip-fitted ball is fixedly attached to an end portion of the sensor beam.

6. The electro-hydraulic servo valve according to claim 4, wherein the slip-fitted ball is movably mounted onto the spool valve by being positioned within a groove of the spool valve.

7. The electro-hydraulic servo valve according to claim 1, wherein the position sensor is fixedly mounted to the housing via a mounting skim.

8. The electro-hydraulic servo valve according to claim 7, wherein the mounting skim facilitates alignment of the position sensor with respect to the spool valve.

9. The electro-hydraulic servo valve according to claim 1, further comprising a controller for receiving an input from the position sensor.

10. The electro-hydraulic servo valve according to claim 9, wherein the controller is mounted in an aperture formed in the housing.

11. The electro-hydraulic servo valve according to claim 9, wherein the controller determines the position of the spool valve within the bore of the housing.

12. The electro-hydraulic servo valve according to claim 11, wherein the position of the spool valve determined by the controller is provided to a torque motor as positioning information.

13. The electro-hydraulic servo valve according to claim 1, further comprising a connector assembly for receiving a signal from the position sensor.

14. The electro-hydraulic servo valve according to claim 13, wherein the connector assembly provides the signal to an external processing device.

15. The electro-hydraulic servo valve according to claim 13, wherein the connector assembly is mounted in an aperture formed in the housing.

16. The electro-hydraulic servo valve according to claim 1, wherein the piezo-resistive components mounted on the sensor beam alter their resistances in accordance with a deflection amount of the sensor beam.

17. The electro-hydraulic servo valve according to claim 1, wherein the piezo-resistive components mounted on the sensor beam form a Wheatstone bridge.

18. The electro-hydraulic servo valve according to claim 1, further comprising a second position sensor mounted to the housing for determining the position of the spool valve.

19. The electro-hydraulic servo valve according to claim 18, wherein the second position sensor extends through the housing and is connected to the spool valve perpendicularly to the linear movement of the spool valve.

20. A method for determining a position of a spool valve of an electro-hydraulic servo valve, said method comprising the steps of:
receiving, as an input, resistance values of a position sensor having a sensor beam with piezo-electric components mounted thereon;
determining a deflection amount of the sensor beam based on the resistance values; and
determining the position of the spool valve based on the deflection amount,
wherein the position sensor is connected to the spool valve by extending through a housing of the electro-hydraulic servo valve and being positioned perpendicular to a linear movement of the spool valve, the spool valve moving within a bore of the housing and deflecting the sensor beam.
